(19) United States
(12) Patent Application Publication
(10) Pub. No.: US 2023/0366765 A1
(43) Pub. Date: Nov. 16, 2023

(54) Pressure Sensor

(71) Applicant: Measurement Specialties (China) Ltd., Shenzhen City (CN)

(72) Inventors: Tinghui (Felix) Fu, Shenzhen (CN); Xu Liang, Shenzhen (CN); Long (Allen) Wang, Shenzhen (CN)

(73) Assignee: Measurement Specialties (China) Ltd., Shenzhen City (CN)

(21) Appl. No.: 18/315,147

(22) Filed: May 10, 2023

(30) Foreign Application Priority Data
May 12, 2022 (CN) 202210516774.4

(51) Int. Cl. G01L 19/00; G01L 19/14

(52) U.S. Cl. CPC G01L 19/0038; G01L 19/14

(57) ABSTRACT

A pressure sensor includes a housing, a pressure detection chip, a circuit board and a terminal assembly. The housing defines an installation chamber and an inner cavity for accommodating fluid. The pressure detection chip is fixed within the installation chamber of the housing and is adapted to detect fluid pressure in the inner cavity. The circuit board is fixed within the installation chamber of the housing and electrically connects to the pressure detection chip. The terminal assembly includes a cover rotatably installed in an opening of the installation chamber of the housing and an elastic output terminal that passes through and is fixed to the cover.

### CROSS-REFERENCE TO RELATED APPLICATION

This application claims the benefit of Chinese Patent Application No. CN202210516774.4 filed on May 12, 2022 in the State Intellectual Property Office of China, the whole disclosure of which is incorporated herein by reference.

### FIELD OF THE INVENTION

The present invention relates to a pressure sensor.

### BACKGROUND

In the prior art, after a pressure sensor (particularly, a threaded pressure sensor) is installed on a tested device, there is a large random error in a direction and position of an output terminal of the pressure sensor. This error cannot be accurately adjusted to a predetermined direction and position, causing inconvenience to users.

### SUMMARY

A pressure sensor according to an embodiment of the present disclosure includes a housing, a pressure detection chip, a circuit board and a terminal assembly. The housing defines an installation chamber and an inner cavity for accommodating fluid. The pressure detection chip is fixed within the installation chamber of the housing and is adapted to detect fluid pressure in the inner cavity. The circuit board is fixed within the installation chamber of the housing and electrically connects to the pressure detection chip. The terminal assembly includes a cover rotatably installed in an opening of the installation chamber of the housing and an elastic output terminal that passes through and is fixed to the cover.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a schematic diagram of a pressure sensor according to an exemplary embodiment of the present invention;

FIG. 2 is an axial cross-sectional view of a pressure sensor according to an exemplary embodiment of the present invention;

FIG. 3 is a partially enlarged schematic diagram of the pressure sensor shown in FIG. 2; and

FIG. 4 is an illustrative perspective view of a circuit board of a pressure sensor according to an exemplary embodiment of the present invention.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present invention, a pressure sensor is provided. The pressure sensor comprises a housing, a pressure detection chip, a circuit board and a terminal assembly. The housing is formed with an installation chamber and an inner cavity for accommodating fluid. The pressure detection chip is fixed in the installation chamber of the housing for detecting fluid pressure in the inner cavity. The circuit board is fixed in the installation chamber of the housing and electrically connected to the pressure detection chip. The terminal assembly includes a cover rotatably installed in an opening of the installation chamber of the housing and an elastic output terminal that passes through and is fixed to the cover. An arc-shaped conductive chute is formed on the circuit board, and the elastic output terminal slides in electrical contact with the arc-shaped conductive chute. When the cover is rotated, the elastic output terminal slides along the arc-shaped conductive chute to adjust the direction and/or position of the elastic output terminal.

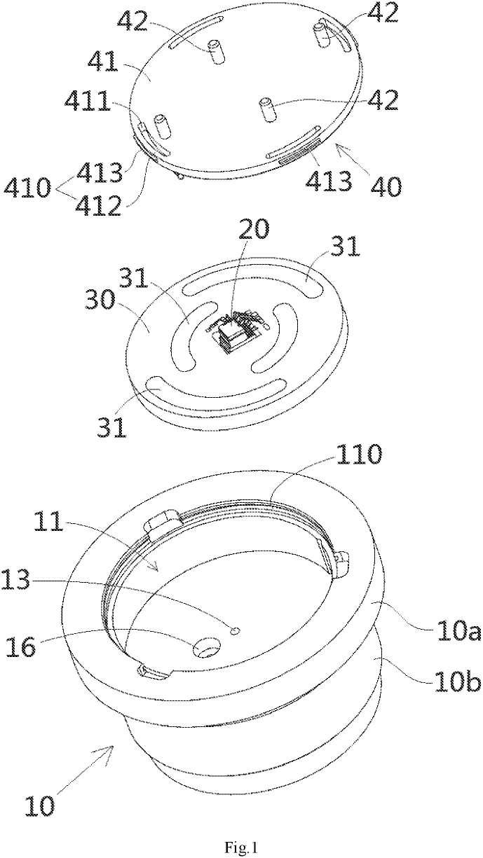

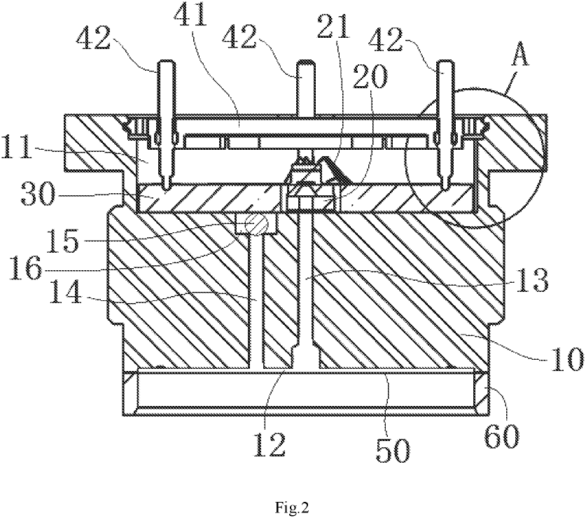

FIG. 1 is a schematic diagram of a pressure sensor according to an exemplary embodiment of the present invention. FIG. 2 is an axial cross-sectional view of a pressure sensor according to an exemplary embodiment of the present invention. As shown in FIGS. 1 and 2, the pressure sensor mainly includes a housing 10, a pressure detection chip 20, a circuit board 30, and a terminal assembly 40. The housing 10 can be a metal housing. A installation chamber 11 for mounting the pressure detection chip 20 and the circuit board 30 and an inner cavity 12,13,14 for accommodating fluid are formed in the housing 10.

The pressure detection chip 20 is fixed in the installation chamber 11 of the housing 10 to detect fluid pressure in the inner cavity 12, 13, 14. The circuit board 30 is fixed in the installation chamber 11 of the housing 10 and electrically connected to the pressure detection chip 20.

The terminal assembly 40 includes a cover 41 and an elastic output terminal 42. The cover 41 is rotatably mounted in the opening of the installation chamber 11 of the housing 10. The elastic output terminal 42 passes through the cover 41 and is fixed to the cover 41 for outputting the detected pressure signal.

An arc-shaped conductive chute 31 is formed on the circuit board 30, and the elastic output terminal 42 slides in electrical contact with the arc-shaped conductive chute 31. Therefore, when the cover 41 is rotated, the elastic output terminal 42 slides along the arc-shaped conductive chute 31, enabling the direction and/or position of the elastic output terminal 42 to be accurately adjusted to a predetermined direction and/or position.

An external thread (not shown) suitable for threaded connection to a threaded hole of a tested device (not shown) is formed on the outer peripheral surface of the housing 10, and the pressure sensor is suitable for threaded connection and fixation to the tested device through the external thread.

An annular groove 110 is formed on the inner peripheral surface of the opening of the installation chamber 11 of the housing 10, and an elastic snap 410 is formed on the peripheral portion of the cover 41. The elastic snap 410 is adapted to be moved between a locking position engaged with the annular groove 110 and an unlocking position separated from the annular groove 110. When the elastic snap 410 is in the locking position, the terminal assembly 40 is locked onto the housing 10. When the elastic snap 410 is in the unlocking position, the terminal assembly 40 can be rotated relative to the housing 10. The elastic snap 410 is adapted to be moved from the locking position to the unlocking position under the action of a pressing pressure applied to the cover 41. The elastic snap 410 is adapted to automatically reset from the unlocking position to the locking position under the elastic force of the elastic output terminal 42 itself.

An arc-shaped slot hole 411 is formed on the cover 41, which is close to the peripheral portion of the cover 41 to form an elastic arm 412 capable of radial elastic deformation on the peripheral portion of the cover 41. The arc-shaped slot hole 411 provides a radially inward elastic deformation space for the elastic arm 412. The elastic snap 410 includes an arc-shaped protrusion 413 and the aforementioned elastic arm 412. The arc-shaped protrusion 413 is formed on the outer side of the elastic arm 412 opposite to the arc-shaped slot hole 411 and is adapted to engage with the annular groove 110 on the housing 10. When the cover 41 is installed into the opening of the installation chamber 11 of the housing 10, the cover 41 covers the opening of the installation chamber 11 of the housing 10.

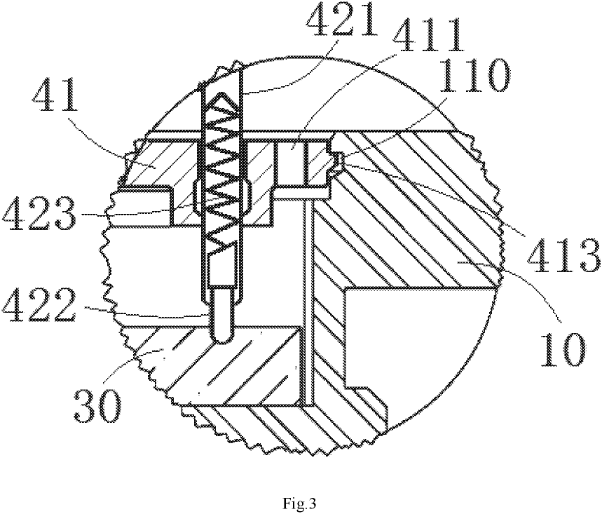

FIG. 3 shows a partially enlarged schematic of the pressure sensor shown in FIG. 2. As shown in FIGS. 1-3, the elastic output terminal 42 includes a cylinder 421, a probe 422, and a spring 423. The cylinder 421 is fixed to the cover 41. The probe 422 is movably mounted in the cylinder 421, like a retractable piston. The spring 423 is housed in the cylinder 421 and compressed between the cylinder 421 and the probe 422. The end of the probe 422 extends out of the cylinder 421 and slides in electrical contact with the arc-shaped conductive chute 31 on the circuit board 30.

However, it should be understood that the elastic output terminal 42 of the present invention is not limited to the illustrated embodiment. For example, in another exemplary embodiment of the present invention, the elastic output terminal 42 is an integral part, and the elastic output terminal 42 includes a main body, an end portion, and an elastic portion connected between the main body and the end portion. The main body of the elastic output terminal 42 is fixed to the cover 41, and the end portion of the elastic output terminal 42 is in sliding electrical contact with the arc-shaped conductive chute 31 on the circuit board 30.

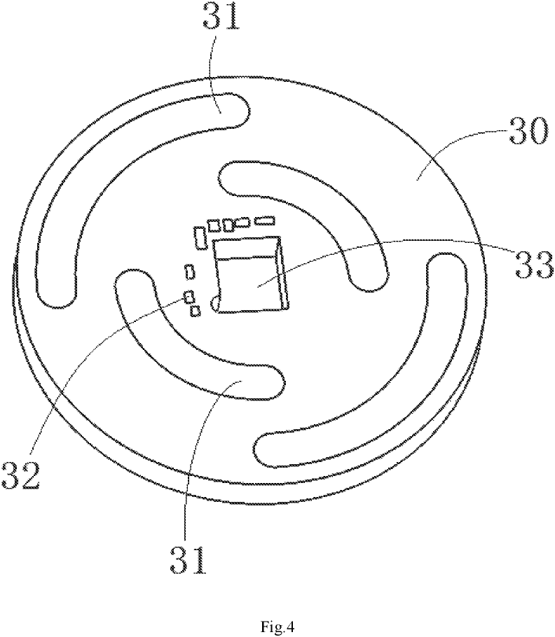

FIG. 4 shows an illustrative perspective view of a circuit board 30 of a pressure sensor according to an exemplary embodiment of the present invention. As shown in FIGS. 1-4, in an exemplary embodiment of the present invention, the center angle of the arc-shaped conductive chute 31 can be greater than zero and less than 360 degrees, greater than zero and less than 270 degrees, greater than zero and less than 180 degrees, or greater than zero and less than 90 degrees.

The terminal assembly 40 includes a plurality of elastic output terminals 42, and the circuit board 30 has a plurality of arc-shaped conductive chutes 31 corresponding to the plurality of elastic output terminals 42, respectively. Multiple arc-shaped conductive chutes 31 are concentric and have equal center angles. The center angle of each of the plurality of arc-shaped conductive chutes 31 is equal to 360 degrees divided by the number of the plurality of arc-shaped conductive chutes 31. The radius of any two circumferentially adjacent arc-shaped conductive chutes 31 among the plurality of arc-shaped conductive chutes 31 is different, so that any two circumferentially adjacent arc-shaped conductive chutes 31 are radially spaced apart. In the exemplary embodiment, the number of multiple arc-shaped conductive chutes 31 is four, and the center angle of each arc-shaped conductive chute 31 is equal to 90 degrees, so that the maximum rotation angle of the terminal assembly 40 is equal to 90 degrees.

Both the pressure detection chip 20 and the circuit board 30 are bonded to the inner bottom surface of the installation chamber 11 of the housing 10, and a collision avoidance hole 33 for avoiding the pressure detection chip 20 is formed on the circuit board 30. The pressure detection chip 20 is electrically connected to the circuit board 30 through a wire 21 and to the arc-shaped conductive chute 31 through a conductive trace on the circuit board 30. A soldering pad 32 is formed on the circuit board 30. One end of the wire 21 is welded to the pressure detection chip 20, and the other end of the wire 21 is welded to the soldering pad 32.

The inner cavity 12,13,14 of the housing 10 includes a fluid accommodation chamber 12 and a first fluid passage 13. The first fluid passage 13 communicates with the fluid accommodation chamber 12 and has an outlet located on the inner bottom surface of the installation chamber 11. The pressure detection chip 20 seals the outlet of the first fluid passage 13 and contacts the fluid in the inner cavity 12,13,14 through the outlet of the first fluid passage 13 to detect the fluid pressure in the inner cavity 12,13,14.

Still referring to FIGS. 1-4, the pressure sensor further includes a diaphragm 50 that is attached to the housing 10 and seals the opening of the fluid accommodation chamber 12 for transmitting an external media pressure (e.g., a fluid pressure inside the tested device) to the fluid in the inner cavity 12,13,14. The pressure sensor further includes a welding ring 60. The periphery of the membrane 50 is clamped and welded between the welding ring 60 and the housing 10.

The inner cavity 12,13,14 of the housing 10 also includes a second fluid passage 14. The second fluid passage 14 communicates with the fluid accommodation chamber 12 and has a fluid filling port for filling the inner cavity 12,13,14 with fluid. The pressure sensor also includes a sealing member 15 attached to the housing 10 and sealing the fluid filling port of the second fluid passage 14.

A receiving recess 16 is formed on the inner bottom surface of the installation chamber 11 of the housing 10. The fluid filling port of the second fluid passage 14 is located on the bottom surface of the receiving recess 16, and the sealing member 15 is accommodated in the receiving recess 16 to prevent the sealing member 15 from interfering with the circuit board 30.The sealing member 15 can be a metal sphere which is welded to the fluid filling port of the second fluid passage 14.

The housing 10 has a first end and a second end opposite to the first end, the installation chamber 11 is located at the first end of the housing 10, and the fluid accommodation chamber 12 is located at the second end of the housing 10. The housing 10 has a base portion 10a located at the first end of the housing 10 and a main body 10b extending between the base portion 10a and the second end of the housing 10. An external thread (not shown) suitable for threaded connection to a threaded hole of a tested device (not shown) is formed on the outer peripheral surface of the main body 10b of the housing 10. The base portion 10a of the housing 10 protrudes radially outward relative to the main body 10b for being positioned outside the threaded hole of the tested device.

According to one embodiment of the present disclosure, the pressure sensor is an oil filled pressure sensor, and the fluid filled in the inner cavity 12,13,14 of the housing 10 can be insulating oil.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A pressure sensor, comprising:
a housing defining an installation chamber and an inner cavity for accommodating fluid;
a pressure detection chip fixed in the installation chamber of the housing and adapted to detect fluid pressure in the inner cavity;
a circuit board fixed in the installation chamber of the housing and electrically connected to the pressure detection chip; and
a terminal assembly including a cover rotatably installed in an opening of the installation chamber of the housing and an elastic output terminal that passes through and is fixed to the cover.

2. The pressure sensor according to claim 1, wherein an arc-shaped conductive chute is formed on the circuit board, and the elastic output terminal slides in electrical contact with the arc-shaped conductive chute.

3. The pressure sensor according to claim 2, wherein when the cover is rotated, the elastic output terminal slides along the arc-shaped conductive chute to adjust at least one of a direction or a position of the elastic output terminal.

4. The pressure sensor according to claim 3, wherein:
an annular groove is formed on an inner peripheral surface of the opening of the installation chamber of the housing, and an elastic snap is formed on the peripheral portion of the cover, the elastic snap is adapted to be moved between a locking position engaged with the annular groove and an unlocking position separated from the annular groove;
when the elastic snap is in the locking position, the terminal assembly is locked on the housing; and
when the elastic snap is in the unlocking position, the terminal assembly is rotatably relative to the housing.

5. The pressure sensor according to claim 4, wherein:
the elastic snap is adapted to be moved from the locking position to the unlocking position under the action of a pressing pressure applied to the cover; and
the elastic snap is adapted to automatically reset from the unlocking position to the locking position under the action of the elastic force of the elastic output terminal.

6. The pressure sensor according to claim 4, wherein:
an arc-shaped slot hole is formed on the cover, and the arc-shaped slot hole is close to the peripheral portion of the cover to form an elastic arm capable of radial elastic deformation at the peripheral portion of the cover; and
the elastic snap comprises the elastic arm, and an arc-shaped protrusion formed on the outer side of the elastic arm opposite to the arc-shaped slot hole and adapted to engage with the annular groove.

7. The pressure sensor according to claim 4, wherein when the cover is installed into the opening of the installation chamber of the housing, the cover covers the opening of the installation chamber of the housing.

8. The pressure sensor according to claim 2, wherein the elastic output terminal comprises:
a cylinder fixed to the cover;
a probe movably mounted in the cylinder; and
a spring received in the cylinder and compressed between the cylinder and the probe, the end of the probe extends out of the cylinder and slides in electrical contact with the arc-shaped conductive chute on the circuit board.

9. The pressure sensor according to claim 2, wherein the elastic output terminal is an integral piece comprising a main body, an end portion, and an elastic portion connected between the main body and the end portion, the main body of the elastic output terminal is fixed to the cover, and the end of the elastic output terminal is in sliding electrical contact with the arc-shaped conductive chute on the circuit board.

10. The pressure sensor according to claim 2, wherein the terminal assembly includes a plurality of elastic output terminals, and the circuit board has a plurality of arc-shaped conductive chutes corresponding to the plurality of elastic output terminals, the plurality of arc-shaped conductive chutes are concentric and have equal center angles.

11. The pressure sensor according to claim 10, wherein:
the center angle of each of the plurality of arc-shaped conductive chutes is equal to 360 degrees divided by the number of the plurality of arc-shaped conductive chutes; and
a radius of any two circumferentially adjacent arc-shaped conductive chutes is distinct such that any two circumferentially adjacent arc-shaped conductive chutes are radially spaced apart.

12. The pressure sensor according to claim 11, wherein the number of the plurality of arc-shaped conductive chutes is four, and the center angle of each arc-shaped conductive chute is equal to 90 degrees.

13. The pressure sensor according to claim 2, wherein the pressure detection chip and the circuit board are both bonded to an inner bottom surface of the installation chamber of the housing, and a collision avoidance hole is formed on the circuit board for avoiding the pressure detection chip.

14. The pressure sensor according to claim 13, wherein:
the pressure detection chip is electrically connected to the circuit board through a wire and to the arc-shaped conductive chute through a conductive trace on the circuit board; and
a welding pad is formed on the circuit board, one end of the wire is welded to the pressure detection chip, and the other end is welded to the welding pad.

15. The pressure sensor according to claim 14, further comprising:
a membrane attached to the housing and sealing the opening of the fluid accommodation chamber; and
a welding ring for welding the membrane to the housing, the membrane adapted to transmit an external media pressure to the fluid in the inner cavity, a periphery of the membrane is clamped and welded between the welding ring and the housing.

16. The pressure sensor according to claim 1, wherein the inner cavity of the housing comprises:
a fluid accommodation chamber; and
a first fluid passage communicating with the fluid accommodation chamber and having an outlet located on an inner bottom surface of the installation chamber, the pressure detection chip seals the outlet of the first fluid passage and contacts the fluid in the inner cavity through the outlet of the first fluid passage to detect fluid pressure in the inner cavity.

17. The pressure sensor according to claim 16, wherein the housing includes:
a first end and a second end opposite to the first end, the installation chamber is located at the first end of the housing, and the fluid accommodation chamber is located at the second end of the housing;
a base portion located at the first end and a main body extending between the base portion and the second end; and
an external thread adapted to threadably connect to a threaded hole of a tested device formed on the outer peripheral surface of the main body of the housing, the base portion of the housing protrudes radially outward relative to the main body.

18. The pressure sensor according to claim 16, wherein:
the inner cavity of the housing further includes a second fluid passage in communication with the fluid accommodation chamber and has a fluid filling port for filling the inner cavity with fluid; and
the pressure sensor further includes a sealing member attached to the housing and sealing the fluid filling port of the second fluid passage.

19. The pressure sensor according to claim 18, wherein:
a receiving recess is formed on the inner bottom surface of the installation chamber of the housing, and the fluid filling port of the second fluid passage is located on the bottom surface of the receiving recess; and
the sealing member is accommodated in the receiving recess to prevent the sealing member from interfering with the circuit board.

20. The pressure sensor according to claim 1, wherein an external thread adapted to threadably engage with a threaded hole of a tested device is formed on an outer peripheral surface of the housing.
